(19) United States
(12) Patent Application Publication
(10) Pub. No.: US 2007/0242782 A1
(43) Pub. Date: Oct. 18, 2007

(54) Channel estimation apparatus and method for interference cancellation in mobile communication system

(75) Inventors: Ki-Young Han, Yongin-si (KR); Keun-Chul Hwang, Seongnam-si (KR); Soon-Young Yoon, Seoul (KR); Sung-Soo Hwang, Suwon-si (KR); June Moon, Seoul (KR); Joo-Hyun Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/717,526

(22) Filed: Mar. 13, 2007

(30) Foreign Application Priority Data
Mar. 13, 2006 (KR) 2006-0023106

(51) Int. Cl. H04L 27/06

(52) U.S. Cl. 375/343

(57) ABSTRACT

Channel estimation apparatus and method for interference cancellation in a mobile communication system are provided. The channel estimation method includes detecting a preamble from a received signal and estimating a primary channel using the detected preamble; calculating a short-term correlation matrix using the primary channel; and estimating a secondary channel using the calculated short-term correlation matrix according to a certain channel estimation scheme.

### PRIORITY

This application claims priority under 35 U.S.C. § 119 to an application filed in the Korean Intellectual Property Office on Mar. 13, 2006 and assigned Serial No. 2006-23106, the contents of which are incorporated herein by reference.

### BACKGROUND OF THE INVENTION

1. Field of the Invention

The present invention relates generally to a mobile communication system, and in particular, to a channel estimation apparatus and method for interference cancellation of a mobile station.

2. Description of the Related Art

Cellular mobile communication systems regulate Signal-to-Interference plus Noise Ratio (SINR) in cell boundary using a frequency reuse factor. The frequency reuse factor is a parameter indicating how far apart the cells using the same frequency resource are positioned. As the frequency reuse factor increases, the SINR of the cell boundary also increases but the frequency utilization diminishes. When the frequency reuse factor is 1, the frequency utilization rises but the SINR of the cell boundary decreases. For example, in systems having the frequency reuse factor 1, Code Division Multiple Access (CDMA) systems mitigate the inter-cell interference by adopting a spreading/dispreading method.

However, of the systems having the frequency reuse factor 1, systems incapable of adopting the spreading/dispreading method are subject to the reception performance degradation of mobile stations. To enhance the reception performance of the mobile station, efforts are made to apply to the mobile stations the conventional interference cancellation method, which was used in part at the base station. To apply the interference cancellation method to the mobile stations, it should be possible to estimate not only a channel of a serving base station but also a channel of the interfering base station to be canceled at the same time.

Downlink channel estimation can be largely divided to a method using a preamble in the first symbol of every frame and a method using a pilot in every burst. The preamble exhibits a high channel estimation accuracy because of its high density compared to the pilot of the data burst. Hence, the channel estimated using the preamble can be used for the burst close to the preamble in light of time. However, as for a burst far from the preamble in view of time, the channel estimated using the preamble degrades the channel estimation performance because of channel changes resulting from a Doppler effect according to the movement of the mobile station and the oscillating frequency difference between the transmitter and the receiver because of frequency offset. Accordingly, in this case, the pilot allocated to each burst has to be used for the channel estimation.

FIG. 1 depicts receptions of a mobile station located in a cell boundary of a mobile communication system.

As the Mobile Station (MS) 100 of FIG. 1 is communicating with a serving Base Station (BS1) 101, signals from adjacent BS2 102 and BS3 103 serve as interference.

The signal received at the MS 100 can be expressed as Equation (1).
yᵢ=hₛxₛ+hᵢxᵢ+ . . . +hⱼ₋₁xⱼ₋₁+wᵢ (1)

In Equation (1), xₛ is a transmit signal of the serving BS, xⱼ is a transmit signal of the j-th interfering BS, hₛ is a channel corresponding to the serving BS, and hⱼ is a channel corresponding to the j-th interfering BS. It is assumed that the number of interfering signals removable by an interference canceller of MS 100 is j−1. w is Additive White Gaussian Noise (AWGN) thermal noise.

The MS 100 can adopt Least Squares (LS) using the pilot as the channel estimation method for the interference cancellation. It is assumed that the channel is the same within a time-frequency block or a tile in consideration of a coherence time and a coherence frequency. On this assumption, the channel is constant for the pilot in the same tile. The greater the coherence time and the coherence bandwidth, that is, the larger time-frequency domain, the greater the number of pilots having the same channel. In addition, it is assumed that BSs 101, 102, and 103 transmit the pilots at the same time-frequency position, and that MS 100 knows the transmitted pilots. Since MS 100 is placed in the cell boundary, the operating Signal-to-Noise Ratio (SNR) is low. Accordingly, it can be assumed that the greater the number of the pilots is subject to the same channel than MS 100 is located in the vicinity of the serving BS 101.

Given the number of pilots in the tile I, a signal of subcarriers including the pilot can be expressed as Equation (2).

$$\begin{matrix}( \begin{matrix}{y}_{1} \\ {y}_{2} \\ ⋮ \\ {y}_{I}\end{matrix} ) = [ \begin{matrix}{x}_{s , 1} & {x}_{1 , 1} & ⋯ & {x}_{J - 1 , 1} \\ {x}_{s , 2} & {x}_{1 , 2} & ⋯ & {x}_{J - 1 , 2} \\ ⋮ & ⋮ & ⋮ & ⋮ \\ {x}_{s , I} & {x}_{1 , I} & ⋯ & {x}_{J - 1 , I}\end{matrix} ] ( \begin{matrix}{h}_{s} \\ {h}_{1} \\ ⋮ \\ {h}_{J - 1}\end{matrix} ) + ( \begin{matrix}{w}_{1} \\ {w}_{2} \\ ⋮ \\ {w}_{I}\end{matrix} ) \\ y = Xh + w\end{matrix} \qquad ( 2 )$$

The LS, which is to minimize the error squares of y and Xh, can be expressed as Equation (3).
e²=(y−Xh)^{H}(y−Xh) (3)

A condition to minimize the error squares can be expressed as Equation (4).

$$\frac{\partial }{\partial h} {e}^{2} = - 2 {X}^{H} ( y - Xh ) = 0 \qquad ( 4 )$$

Hence, the estimated channel using the LS can be expressed as Equation (5).
ĥ=(y−Xh)^{H}(y−Xh) (5)

However, when the channel is estimated using the LS, the MS 100 is subject to the degradation of the channel estimation performance. Therefore, what is needed is a channel estimation method of high performance to improve the interference cancellation capability of the MS.

### SUMMARY OF THE INVENTION

An aspect of the present invention is to substantially solve at least the above problems and/or disadvantages and to provide at least the advantages below. Accordingly, an aspect of the present invention is to provide a channel estimation apparatus and method for interference cancellation in a mobile communication system.

Another aspect of the present invention is to provide a channel estimation apparatus and method for interference cancellation by calculating a correlation matrix between a serving Base Station (BS) signal and an adjacent BS signal, which are measured in a short time interval, and using the calculated correlation in a mobile communication system.

The above aspects are achieved by providing a channel estimation method in a mobile communication system, which includes detecting a preamble from a received signal and performing a primary channel estimation using the detected preamble; calculating a short-term correlation matrix using the primary channel; and performing a secondary channel estimation using the calculated short-term correlation matrix according to a channel estimation scheme.

According to another aspect of the present invention, a channel estimation apparatus in a mobile communication system includes a channel estimator which detects a preamble from a received signal, performs a primary channel estimation using the detected preamble, calculates a short-term correlation matrix using the primary channel, and performs a secondary channel estimation using the calculated short-term correlation matrix according to a channel estimation scheme.

### BRIEF DESCRIPTION OF THE DRAWINGS

The above and other objects, features and advantages of the present invention will become more apparent from the following detailed description when taken in conjunction with the accompanying drawings in which:

FIG. 1 depicts receptions of a Mobile Station (MS) in a mobile communication system;

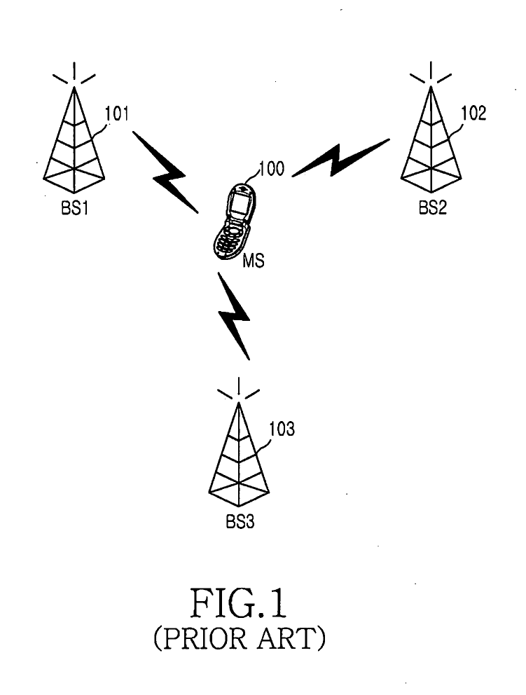

FIG. 2 is a block diagram of an interference cancellation apparatus of an MS in a mobile communication system according to the present invention;

FIG. 3 is a flowchart outlining a channel estimation method for the interference cancellation in the mobile communication system according to the present invention; and

FIG. 4 is a graph comparing a performance between the related art and the channel estimation method of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a channel estimation apparatus and method for interference cancellation in a mobile communication system.

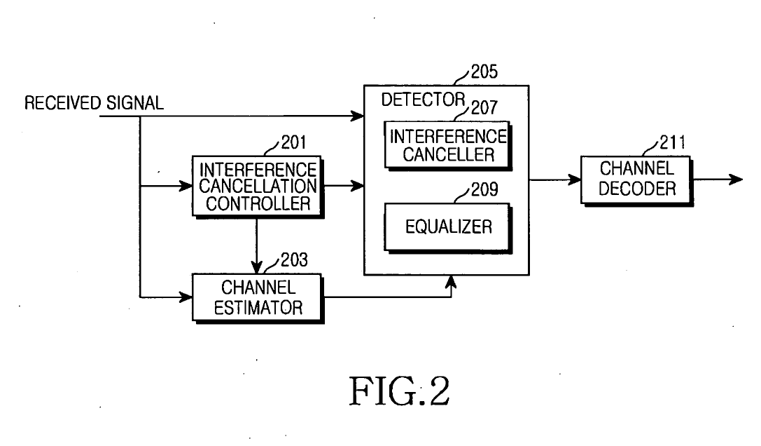

FIG. 2 is a block diagram of an interference cancellation apparatus of a Mobile Station (MS) in a mobile communication system according to the present invention. The interference cancellation apparatus of the MS includes an interference cancellation controller 201, a channel estimator 203, a detector 205, and a channel decoder 211. The detector 205 includes an interference canceller 207 and an equalizer 209.

The interference cancellation controller 201 of FIG. 2 determines whether to cancel interference from a received signal based on a power level of the received signal or a Carrier to Interference and Noise Ratio (CINR) value estimated from a preamble, and outputs the determination result to the channel estimator 203 and the detector 205. For example, when the power level of the received signal or the CINR value is greater than a threshold, the interference cancellation controller 201 does not perform the interference cancellation. When the power level of the CINR value is less than the threshold, the interference cancellation controller 201 performs the interference cancellation. The interference cancellation controller 201 determines in the current frame whether to use the interference canceller 207 or the equalizer 209.

The channel estimator 203 carries out a primary channel estimation using the preamble of the received signal according to the interference cancellation determination result from the interference cancellation controller 201, induces a short-term correlation matrix using the primary estimated channel, and carries out a secondary channel estimation using the induced short-term correlation matrix according to a short-term Minimum Mean Squared Error (MMSE) channel estimation scheme. The channel estimator 203 outputs the estimated channel value to the detector 205. When the interference cancellation controller 201 determines to cancel the interference of the received signal, the channel estimator 203 estimates channels of every signal transmitted from a serving Base Station (BS) and adjacent interfering BSs. By contrast, when the interference cancellation controller 201 determines to compensate for the received signal rather than the cancel the interference of the received signal, the channel estimator 203 merely estimates the channel of the signal transmitted from the serving BS.

The detector 205 cancels the interference of the received signal or compensates for the received signal according to the interference cancellation determination result from the interference cancellation controller 201, and outputs the interference-free signal or the compensated signal to the channel decoder 211. When the interference cancellation controller 201 determines to perform the interference cancellation of the received signal, the interference canceller 207 of the detector 205 is driven. The interference canceller 207 cancels the interference of the received signal using the channels of the serving BS and the interfering BSs, which are estimated at the channel estimator 203. When the interference cancellation controller 201 determines to compensate for the received signal rather than the interference cancellation, the equalizer 209 of the detector 205 is driven. The equalizer 209 compensates for the received signal using the channel of the serving BS, which is estimated at the channel estimator 203.

The channel decoder 211 channel-decodes the signal from the detector 205 according to a certain decoding scheme and outputs the decoded signal.

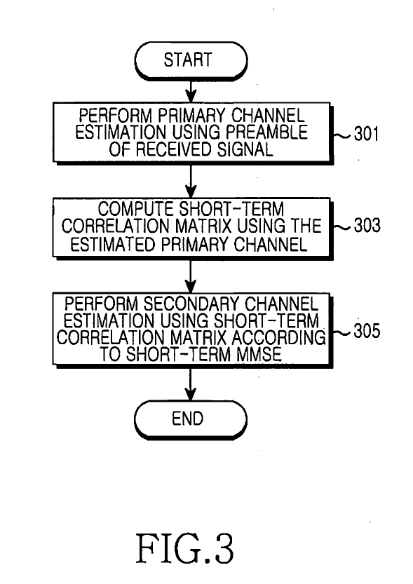

FIG. 3 is a flowchart outlining a channel estimation method for the interference cancellation in the mobile communication system according to the present invention.

In FIG. 3, in step 301 the channel estimator 203 detects the preamble from the received signal and performs the primary channel estimation using the detected preamble. According to the interference cancellation determination result fed from the interference cancellation controller 201, only the channel of the serving BS can be estimated or the channels of both the serving BS and the interfering BSs can be estimated. Specifically, when the interference cancellation controller 201 determines to cancel the interference of -the received signal, the channel estimator 203 estimates the channels of the signals transmitted from not only the serving BS but also the interfering BSs. When the interference cancellation controller 201 determines to compensate for the received signal rather than to cancel the interference, the channel estimator 203 estimates only the channel of the signal transmitted from the serving BS. The preamble is a specific PN code transmitted by modulating it according to a certain modulation scheme.

For example, assume that the number of the subcarriers within the tile having the same band as the data burst is M and the number of subcarriers allocated a pseudo-noise (PN) sequence is p, the channel estimator 203 can estimate the serving BS channel hₛ(p) and the interfering BS channel hᵢ(p) at the position of the p-ary subcarriers allocated the PN sequence. Generally, M is greater than or equal to p. The channel at the position of the remaining (M−p)-ary subcarriers can be estimated through interpolation of the channel of the subcarriers allocated the adjacent PN sequence.

If there exists n-ary subcarriers between the adjacent subcarriers allocated the PN sequence, the serving BS channel at the nₘ-th subcarrier can be estimated based on Equation (6).

$${\hat{h}}_{s} ( {n}_{m} ) = \frac{( n - {n}_{m} ) {\hat{h}}_{s} ( p - 1 ) + {n}_{m} {\hat{h}}_{s} ( p )}{n} \qquad ( 6 )$$

Based on Equation (6), all of channels at the m-ary positions in the tile are acquired. Likewise, the channel of the interfering BS can be estimated.

The channel estimator 203 calculates the short-term correlation matrix using the primary estimated channel in step 303.

The correlation matrix R of the serving BS channel and the interfering BS channels can be expressed as Equation (7). Since the BS uses a high-performance oscillator, compared to the MS, it is assumed that the frequency offset between the BSs can be ignored compared to the frequency offset between the MS and the BS.

$$R = E \{ [ \begin{matrix}{h}_{s} \\ {h}_{i}\end{matrix} ] [ \begin{matrix}{h}_{s}^{*} & {h}_{i}^{*}\end{matrix} ] \} = ( \begin{matrix}E \{ {\vert {h}_{s} \vert}^{2} \} & E \{ {h}_{s} {h}_{i}^{*} \} \\ E \{ {h}_{i} {h}_{s}^{*} \} & E \{ {\vert {h}_{i} \vert}^{2} \}\end{matrix} ) \qquad ( 7 )$$

In Equation (7), the superscript * denotes a conjugate. When there is the frequency offset Δf and time nTₛ passes for the sampling time Tₛ, the frequency offset between the MS and the BS changes only the phase of the channel. Thus, diagonal terms of the correlation matrix do not change and off-diagonal terms also do not change, as demonstrated in Equation (8). That is, the correlation matrix is not affected by the frequency offset according to time.
E{hₛ(nTₛ)hᵢ*(nTₛ)}=E{hₛe^{j2πΔfnT}^{ₛ}(hᵢe^{j2πΔfnT}^{ₛ})*}=E{hₛhᵢ} (8)

Accordingly, when the two channels are estimated using the correlation matrix R of the serving BS and the interfering BS, the effect of the frequency offset can be removed. The channel changes according to the time because of the frequency offset and the Doppler effect. In the channel estimation using the preamble, since the frequency offset experiences a greater amount of change in the channel according to time than the Doppler effect experiences, it is necessary to mitigate the effect of the frequency offset. As a result, when using the channel estimated using the preamble, the degradation of the channel estimation performance due to the change in the channel according to the frequency offset can be addressed.

Elements of the short-term correlation matrix computable using the primary estimated channel can be expressed as Equation (9) which takes into account the two channels of the serving BS and the interfering BS.

$$\begin{matrix}E \{ {\vert {h}_{s} \vert}^{2} \} \approx \frac{1}{M} {\sum }_{m = 1}^{M} {\vert {\hat{h}}_{s} ( m ) \vert}^{2} \\ E \{ {\vert {h}_{i} \vert}^{2} \} \approx \frac{1}{M} {\sum }_{m = 1}^{M} {\vert {\hat{h}}_{i} ( m ) \vert}^{2} \\ E {\{ {h}_{i} {h}_{s}^{*} \}}^{*} = E \{ {h}_{s} {h}_{i}^{*} \} \approx \frac{1}{M} {\sum }_{m = 1}^{M} {\hat{h}}_{s} ( m ) {\hat{h}}_{i}^{*} ( m )\end{matrix} \qquad ( 9 )$$

In step 305 the channel estimator 203 performs the secondary channel estimation using the calculated short-term correlation matrix according to the short-term MMSE channel estimation scheme.

The short-term MMSE minimizes the Mean Squired Error (MSE) which is expressed as Equation (10).
J=E{|h−Gy|²} (10)

G minimizing Equation (10) is referred to as an MMSE weight matrix. As shown in Equation (12), G can be acquired using the orthogonal principle of Equation (11).
E{(h−Gy)y^{H}}=0 (11)
G=R_{hy}R_{y}⁻¹ (12)

R_{ab} denotes the correlation matrix of a and b. Equation (12) can be expressed as Equation (13).
G=RₕX^{H}(XRₕX^{H}+σ²I)⁻¹ (13)

By applying the Sherman-Morrison formula, Equation (14) is acquired.
G=RₕX^{H}(XRₕX^{H}+σ²Rₕ⁻¹)⁻¹X^{H} (14)

Rₕ denotes the correlation matrix. The channel h can be estimated by multiplying G by y based on h=Gy. Compared to Equation (13), the computational complexity can be greatly reduced by applying the Sherman-Morrison formula as in Equation (14). Next, the channel estimator 203 terminates the channel estimation algorithm of the present invention.

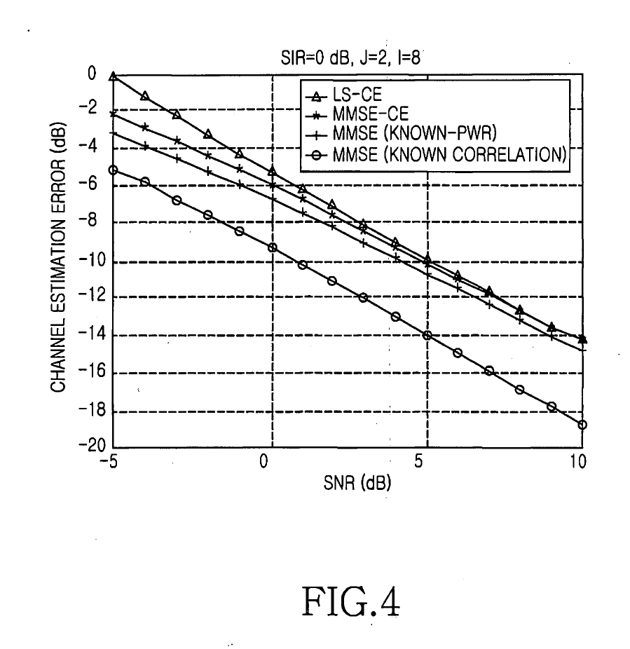

FIG. 4 is a graph comparing a performance between the related art and the channel estimation method of the present invention. The graph shows the channel estimation performance using eight pilots at the MS having the same power as one interfering cell serving BS, that is, having the Signal-to-Interference Ratio (SIR) of 0 dB.

Referring to FIG. 4, the channel estimation error of the conventional LS-CE has the gain of 4˜5 dB compared to the operating SNR. The MMSE-CE is the channel estimation scheme acquired from the correlation matrix for a long term and has the gain of 0˜1 dB compared to the LS-CE. Since the channels of the serving BS and the interfering BS are independent of each other for the long term, the off-diagonal terms of the correlation matrix are zero. Hence, it can be said that the MMSE-CE is the channel estimation scheme assuming that the correlation matrix is a unit matrix.

By contrast, for a short term, the channels of the serving BS and the interfering BS in each tile are not independent. Thus, the off-diagonal terms of the correlation matrix are not zero any more. Even if the SIR is 0 dB, the diagonal terms are not the same any more. The MMSE (Known-pwr) is the channel estimation scheme on the assumption that the powers of the serving BS and the interfering BS are accurately known. Because the exact values of the diagonal terms of the correlation matrix for the short term are known but the values of the off-diagonal terms are unknown,, the off-diagonal terms are assumed to be zero for the channel estimation. Lastly, the MMSE (Known correlation) of the present invention acquires the gain of 2˜3 dB because it knows the accurate short-term correlation matrix, compared to the MMSE (Known-Pwr).

As set forth above, the mobile communication system calculates the correlation matrix of the serving BS signal and the adjacent BS signal measured over a short time interval and estimates the channels using the acquired correlation matrix. Therefore, the effective channel estimation can improve the interference cancellation capability of the MS and enhance the reception performance.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A channel estimation method in a mobile communication system, comprising:
detecting a preamble from a received signal and estimating a primary channel using the detected preamble;
calculating a short-term correlation matrix using the primary channel; and
estimating a secondary channel using the calculated short-term correlation matrix according to a channel estimation scheme.

2. The channel estimation method of claim 1, wherein the channel estimation scheme is a short-term Minimum Mean Squared Error (MMSE) channel estimation scheme.

3. The channel estimation method of claim 1, wherein the primary channel estimating step comprises:
estimating a corresponding channel using a preamble at subcarriers allocated a preamble, and estimating a channel at subcarriers not allocated a preamble by interpolating a channel of subcarriers allocated an adjacent preamble.

4. The channel estimation method of claim 3, wherein the channel of a serving Base Station (BS) at subcarriers not allocated the preamble is estimated based on
$${\hat{h}}_{s} ( {n}_{m} ) = \frac{( n - {n}_{m} ) {\hat{h}}_{s} ( p - 1 ) + {n}_{m} {\hat{h}}_{s} ( p )}{n}$$
where n denotes a number of subcarriers not allocated a preamble between adjacent subcarriers allocated a preamble, ĥₛ(nm) denotes a channel of the serving BS at a nₘ-th subcarrier, p denotes a number of subcarriers allocated a preamble, and hₛ(p) denotes a channel of the serving BS estimated at the p-ary subcarriers allocated a preamble.

5. The channel estimation method of claim 4, wherein the channel of an interfering BS at subcarriers not allocated a preamble is estimated in the same manner as the channel of the serving BS.

6. The channel estimation method of claim 1, wherein elements of the short-term correlation matrix are estimated based on
$$\begin{matrix}E \{ {\vert {h}_{s} \vert}^{2} \} \approx \frac{1}{M} {\sum }_{m = 1}^{M} {\vert {\hat{h}}_{s} ( m ) \vert}^{2} \\ E \{ {\vert {h}_{i} \vert}^{2} \} \approx \frac{1}{M} {\sum }_{m = 1}^{M} {\vert {\hat{h}}_{i} ( m ) \vert}^{2} \\ E {\{ {h}_{i} {h}_{s}^{*} \}}^{*} = E \{ {h}_{s} {h}_{i}^{*} \} \approx \frac{1}{M} {\sum }_{m = 1}^{M} {\hat{h}}_{s} ( m ) {\hat{h}}_{i}^{*} ( m )\end{matrix}$$
where hₛ denotes a channel corresponding to the serving BS and hᵢ denotes a channel corresponding to the i-th interfering BS.

7. The channel estimation method of claim 2, wherein the short-term MMSE channel estimation scheme estimates the channel based on
G=(X^{H}X+σ²Rₕ⁻¹)⁻¹X^{H}
where G denotes an MMSE weight matrix and Rₕ denotes the correlation matrix.

8. A channel estimation apparatus in a mobile communication system, comprising:
a channel estimator which detects a preamble from a received signal, estimates a primary channel using the detected preamble, calculates a short-term correlation matrix using the primary channel, and estimates a secondary channel using the calculated short-term correlation matrix according to a channel scheme.

9. The channel estimation apparatus of claim 8, further comprising:
an interference cancellation controller for determining whether to cancel interference of the received signal by estimating a Carrier to Interference and Noise Ratio (CINR) of the received signal, and outputs the determination result to the channel estimator and a detector;
the channel estimator for estimating channels of a serving Base Station (BS) and an interfering BS using a preamble of the received signal according to the interference cancellation determination result; and
the detector for canceling the interference of the received signal or compensating for the received signal using the estimated channel values according to the interference cancellation determination result.

10. The channel estimation apparatus of claim 9, wherein the interference cancellation controller determines not to perform the interference cancellation of the received signal when the CINR is greater than a threshold, and determines to perform the interference cancellation of the received signal when the CINR is less than or equal to the threshold.

11. The channel estimation apparatus of claim 9, wherein the channel estimator estimates every channel of signals transmitted from the serving BS and the interfering BS when the interference cancellation controller determines to cancel the interference of the received signal, and the channel estimator estimates only the channel of signals transmitted from the serving BS when the interference cancellation controller determines to compensate for the received signal rather than to cancel the interference.

12. A channel estimation apparatus in a mobile communication system, comprising:
means for detecting a preamble from a received signal and estimating a primary channel using the detected preamble;
means for calculating a short-term correlation matrix using the primary channel; and
means for estimating a secondary channel using the calculated short-term correlation matrix according to a channel estimation scheme.

13. The channel estimation apparatus of claim 12, wherein the channel estimation scheme is a short-term Minimum Mean Squared Error (MMSE) channel estimation scheme.

14. The channel estimation apparatus of claim 12, wherein the function of estimating the primary channel comprises:
estimating a corresponding channel using a preamble at subcarriers allocated a preamble, and estimating a channel at subcarriers not allocated a preamble by interpolating a channel of subcarriers allocated an adjacent preamble.

15. The channel estimation apparatus of claim 14, wherein the channel of a serving Base Station (BS) at subcarriers not allocated the preamble is estimated based on
$${\hat{h}}_{s} ( {n}_{m} ) = \frac{( n - {n}_{m} ) {\hat{h}}_{s} ( p - 1 ) + {n}_{m} {\hat{h}}_{s} ( p )}{n}$$
where n denotes a number of subcarriers not allocated a preamble between adjacent subcarriers allocated a preamble, ĥₛ(nₘ) denotes a channel of the serving BS at a nₘ-th subcarrier, p denotes a number of subcarriers allocated a preamble, and hₛ(p) denotes a channel of the serving BS estimated at the p-ary subcarriers allocated a preamble.

16. The channel estimation apparatus of claim 15, wherein the channel of an interfering BS at subcarriers not allocated a preamble is estimated in the same manner as the channel of the serving BS.

17. The channel estimation apparatus of claim 12, wherein the short-term correlation matrix are estimated based on
$$\begin{matrix}E \{ {\vert {h}_{s} \vert}^{2} \} \approx \frac{1}{M} {\sum }_{m = 1}^{M} {\vert {\hat{h}}_{s} ( m ) \vert}^{2} \\ E \{ {\vert {h}_{i} \vert}^{2} \} \approx \frac{1}{M} {\sum }_{m = 1}^{M} {\vert {\hat{h}}_{i} ( m ) \vert}^{2} \\ E {\{ {h}_{i} {h}_{s}^{*} \}}^{*} = E \{ {h}_{s} {h}_{i}^{*} \} \approx \frac{1}{M} {\sum }_{m = 1}^{M} {\hat{h}}_{s} ( m ) {\hat{h}}_{i}^{*} ( m )\end{matrix}$$
where hₛ denotes a channel corresponding to the serving BS and hᵢ denotes a channel corresponding to the i-th interfering BS.

18. The channel estimation apparatus of claim 13, wherein the short-term MMSE channel estimation scheme estimates the channel based on
G=(X^{H}X+σ²Rₕ⁻¹)⁻¹X^{H}
where G denotes an MMSE weight matrix and Rₕ denotes the correlation matrix.
